(19) United States
(12) Patent Application Publication
(10) Pub. No.: US 2003/0107807 A1
(43) Pub. Date: Jun. 12, 2003

(54) Optical member and liquid crystal display

(76) Inventors: Yuuji Saiki, Osaka (JP); Masayuki Satake, Osaka (JP); Yasushi Takahashi, Osaka (JP); Takashi Shouda, Osaka (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/015,991

(22) Filed: Dec. 6, 2001

(51) Int. Cl. G02F 1/1335; G02B 5/30; G02B 27/28

(52) U.S. Cl. 359/485

(57) ABSTRACT

In an optical member, a surface of an optical material is bonded to and covered with a protective film having a outer surface roughness Ra of at least 0.03 μm, or in an optical member, an adhesive layer disposed on an uttermost surface of an optical material is provisionally bonded to and covered with a separator having a outer surface roughness Ra of at least 0.03 μm, hardly generates blocking and, even if the optical members are transported or stored in a stacked state and subjected to a process of automatically assembling liquid crystal display and the like, the optical members can be smoothly separated unit by unit from the stack, thereby avoiding stoppage of the assembling line caused by catching plural units, and enabling production of liquid crystal display and the like with a good assembling efficiency.

### BACKGROUND OF THE INVENTION

1. Field of the Invention

The present invention relates to an optical member which hardly generates blocking by stacking, and which provides an excellent efficiency in assembling liquid crystal displays and the like. Further, the present invention relates to a liquid crystal display applying the same.

2. Description of the Background Art

Polarizing plates, retardation plates, and others used for forming liquid crystal display (LCD) and the like are used, for example, as an elliptically polarizing plate in which a polarizing plate and a retardation plate are laminated in advance via an adhesive layer or as an optical member in which an adhesive layer is attached in advance onto a polarizing plate for bonding to another member such as a liquid crystal cell, for the purpose of preventing variation in the quality and providing a more efficient LCD assemblage and the like. In such a case, they are put into practical use as an optical member in which a surface of an optical material is bonded to and covered with a protective film to avoid damaging. Also, they are transported or stored in a state in which the adhesive layer for bonding to another member such as a liquid crystal cell is provisionally bonded to and covered with a separator so that the exposed adhesive layer may not be unnecessarily bonded or contaminated.

However, regarding the conventional optical members, when they are subjected to a process of automatically assembling liquid crystal displays and the like after being transported or stored in stacking, blocking occurs to prevent separation of optical members unit by unit, and plural units are caught, whereby an assembling apparatus detects the abnormality of operation to stop the assembling line, thus raising a problem of decrease in the assembling efficiency.

### SUMMARY OF THE INVENTION

Thus, an object of the present invention is to develop an optical member which hardly generates blocking and which ensures that, even if the optical members are transported or stored in stacking state and subjected to a process of automatically assembling liquid crystal displays and the like, the optical members can be smoothly separated unit by unit from the stack, thereby avoiding stoppage of the assembling line caused by catching plural units, and enabling production of liquid crystal displays and the like with a good assembling efficiency.

The aforesaid object of the present invention has been achieved by the following means.

The present invention provides:

1. An optical member in which a surface of an optical material is bonded to and covered with a protective film having a outer surface roughness Ra of at least 0.03 μm.

2. The optical member in the above-mentioned 1, wherein the protective film is disposed on one surface of the optical material, and a separator is provided on the other surface of the optical material via an adhesive layer.

3. The optical member in the above-mentioned 1, wherein the optical material comprises a polarizing plate.

4. The optical member in the above-mentioned 1, wherein the optical material comprises a polarizing plate, and at least one of a retardation plate and a brightness enhanced plate.

5. An optical member in which an adhesive layer disposed on an uttermost surface of an optical material is provisionally bonded to and covered with a separator having a outer surface roughness Ra of at least 0.03 μm.

6. The optical member in the above-mentioned 5, wherein the separator is disposed on one surface of the optical material, and a protective film is provided on the other surface of the optical material.

7. The optical member in the above-mentioned 5, wherein the optical material comprises has a polarizing plate.

8. The optical member in the above-mentioned 5, wherein the optical material comprises a polarizing plate, and at least one of a retardation plate and a brightness enhanced plate.

9. A liquid crystal display having an optical member in the above-mentioned 1.

The aforesaid optical member of the present invention ensures that, even if the optical members are transported or stored in stacking, the rough surface imparted on the outer surface of the protective film prevents blocking and, when the stack is subjected to a process of automatically assembling liquid crystal displays and the like, the optical members can be smoothly separated unit by unit from the stack, thereby avoiding stoppage of the assembling line caused by catching plural units, and enabling production of liquid crystal displays and the like with a good assembling efficiency.

Also, the aforesaid optical member of the present invention ensures that, even if the optical members are transported or stored in stacking, the rough surface imparted on the outer surface of the separator prevents blocking and, when the stack is subjected to a process of automatically assembling liquid crystal displays and the like, the optical members can be smoothly separated unit by unit from the stack, thereby avoiding stoppage of the assembling line caused by catching plural units, and enabling production of liquid crystal displays and the like with a good assembling efficiency.

### BRIEF DESCRIPTION OF THE DRAWINGS

FIG. 1 is a cross-sectional view illustrating an example of an optical member;

FIG. 2 is a cross-sectional view illustrating an example of an optical member;

FIG. 3 is a cross-sectional view illustrating another example of an optical member; and

FIG. 4 is a cross-sectional view illustrating still another example of an optical member.

### DESCRIPTION OF THE PREFERRED EMBODIMENTS

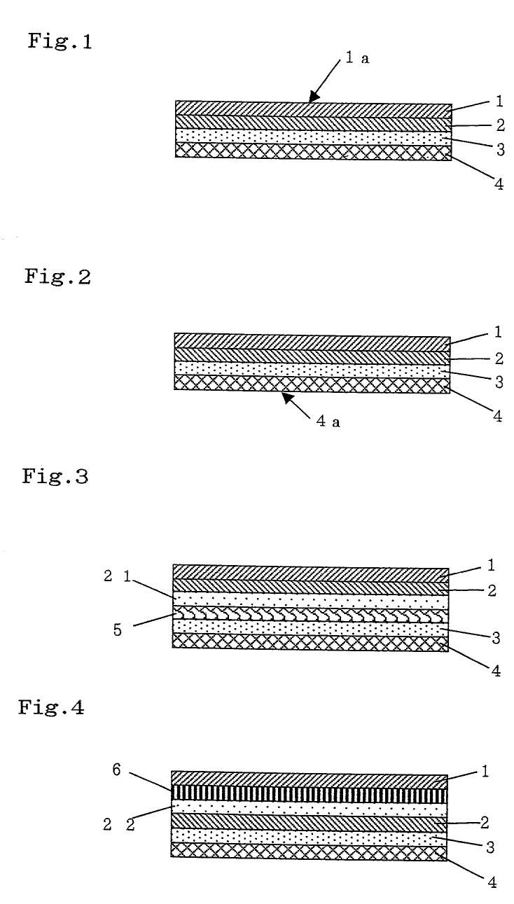

An optical member according to the present invention is constructed in such a manner that a surface of an optical material, particularly one surface thereof, is bonded to and covered with a protective film whose outer surface has a surface roughness Ra of at least 0.03 μm and, in accordance with the needs, a separator is provided on the other surface of the optical material via an adhesive layer. An example thereof is shown in FIG. 1, where a protective film 1, a polarizing plate 2 serving as an optical material, an adhesive layer 3, and a separator 4 are shown. The reference numeral 1a designates an outer surface of the protective film.

Further, an optical member according to the present invention is constructed in such a manner that an adhesive layer disposed on an uttermost surface of an optical material, particularly one side thereof, is provisionally bonded to and covered with a separator whose outer surface has a surface roughness Ra of at least 0.03 μm and, in accordance with the needs, the other surface side of the optical material is bonded to and covered with a protective film. An example thereof is shown in FIG. 2, where a protective film 1, a polarizing plate 2 serving as an optical material, an adhesive layer 3, and a separator 4 are shown. The reference numeral 4a designates an outer surface of the separator.

FIGS. 3 and 4 each show an example in which a retardation plate 5 or a brightness enhanced plate 6 is disposed on the polarizing plate 2 via an adhesive layer 21, 22, as an optical member.

The optical material may be a suitable one used for the formation of a liquid crystal display, such as a polarizing plate, a retardation plate, an elliptically polarizing plate obtained by lamination of these, or a brightness enhanced plate, and the kind of the optical material is not particularly limited. Therefore, the polarizing plate may be a reflecting type, a semitransparent type, or the like. Further, the retardation plate may be a half wavelength plate, a quarter wavelength plate, one having a suitable object such as viewing angle compensation, or the like. In the case of an optical material of a laminate type such as the aforesaid elliptically polarizing plate, the lamination thereof may have been carried out via a suitable bonding means such as an adhesive layer.

Examples of the aforesaid polarizing plate include a polarizing film obtained by allowing a dichroic substance such as iodine or a dye to be adsorbed onto a hydrophilic polymer film such as a polyvinyl alcohol series film, partially formalized polyvinyl alcohol series film, ethylene/vinyl acetate copolymer series partially saponified film, or cellulose series film and stretching the film; or a polyene oriented film such as a dehydrated product of polyvinyl alcohol or a dehydrochlorinated product of polyvinyl chloride. The polarizing plate may have a transeparent protective layer onto one or both surface of the polarizing film

On the other hand, the reflecting type polarizing plate is for forming a liquid crystal display or the like of a type such that the incident light from the viewing side (display side) is reflected for display. This has an advantage in that the incorporation of a light source such as a backlight can be omitted to facilitate fabrication of a liquid crystal display having a reduced thickness. The reflecting type polarizing plate may be formed by a suitable method such as a method of attaching a reflecting layer made of metal or the like onto one surface of a polarizing film, optionally via a transparent protective layer or the like.

A specific example of the reflecting type polarizing plate may be one in which a foil or a vapor-deposited film made of a reflecting metal such as aluminum is attached onto one surface of a transparent protective layer made of an optionally matted film or the like. The reflecting type polarizing plate may be one having a reflecting layer of a fine undulating structure on the aforesaid diffusing type transparent protective layer.

Further, the reflecting layer is preferably used in a state in which the reflecting surface thereof is covered with a transparent protective film, a polarizing plate, or the like, in view of preventing decrease in the reflectivity caused by oxidation, hence long-term duration of initial reflectivity, avoidance of separately attaching a protective layer, and other reasons.

The aforesaid reflecting layer having a fine undulating structure has advantages such as preventing directivity or glittering appearance by diffusing the incident light by random reflection, thereby restraining the unevenness of brightness. Also, the transparent protective layer containing fine particles has such an advantage that the incident light and the reflected light thereof are diffused while passing therethrough, whereby the unevenness of brightness and darkness can be further restrained.

The reflecting layer of a fine undulating structure reflecting the surface fine undulating structure of the transparent protective layer can be formed, for example, by attaching metal directly onto the surface of a transparent protective layer with the use of a suitable method of vapor deposition type such as the vacuum vapor deposition method, the ion plating method, or the sputtering method or plating type or the like.

The aforesaid conventional transparent protective layer may be made of plastics, excellent in transparency, mechanical strength, thermal stability, moisture shielding property, isotropic property, and others. The plastics include, for example, a cellulose series resin such as cellulose triacetate, polyester, polycarbonate, polyamide, polyimide, polyethersulfone, polysulfone, polystyrene, or acrylic resin, polyolefin, or thermosetting or ultraviolet-curing resin such as acryl series, urethane series, acrylurethane series, epoxy series, or silicone series, or the like.

The transparent protective layer may be formed by a suitable method such as a method of coating a polymer or a method of laminating those made into films, and the thickness thereof may be suitably determined. The thickness is typically at most 500 μm, preferably from 1 to 300 μm, more preferably from 5 to 200 μm. The fine particles to be contained in the aforesaid transparent protective film may be, for example, suitable transparent particles such as inorganic fine particles made of silica, alumina, titania, zirconia, tin oxide, indium oxide, cadmium oxide, antimony oxide, or the like having an average particle size of from 0.5 to 50 μm, which may be electrically conductive, or organic fine particles made of a cross-linked or non-cross-linked polymer or the like. The amount of fine particles to be used is typically from 2 to 50 parts by weight, preferably from 5 to 25 parts by weight, with respect to 100 parts by weight of the transparent resin.

Meanwhile, specific examples of the aforesaid retardation plate include birefringent films obtained by stretching a film made of a suitable polymer such as polycarbonate, polyvinyl alcohol, polystyrene, polymethyl methacrylate, polyolefin such as polypropylene, polyallylate, or polyamide, oriented film of liquid crystal polymer, and those in which an oriented layer of liquid crystal polymer is supported with a film.

The retardation plate may be, for example, one having a suitable retardation according to the intended usage such as compensation of various wavelength plates, coloring by birefringence of liquid crystal layer, or viewing angle, or may be a tilted orientation film with controlled refractive index in the thickness direction. Further, two or more kinds of retardation plates may be laminated to control the optical characteristics such as retardation. The aforesaid tilted orientation film can be obtained, for example, by a method of bonding a heat-shrinking film onto a polymer film and subjecting the polymer film to a stretching process and/or a shrinking process under the action of its shrinking force by heating, a method of obliquely orienting a liquid crystal polymer, or the like method.

The optical material may be made of a laminate of two more optical layers such as a laminate of the aforesaid elliptically polarizing plate, reflecting type polarizing plate, or retardation plate. Therefore, as exemplified in FIGS. 3 and 4, the optical material may be a combination of polarizing plate 2 with retardation plate 5 and/or brightness enhanced plate 6, a combination of a reflecting type polarizing plate or semitransparent type polarizing plate with a retardation plate, or the like.

An optical material obtained by lamination of two or more optical layers may be formed by a method of successive and separate lamination in a process of producing a liquid crystal display or the like; however, an optical material having optical layers laminated in advance is excellent in the stability of quality and in the operability of assemblage, thereby providing an advantage of improving the efficiency in producing a liquid crystal display.

The brightness enhanced plate is sometimes referred to as polarizing separating plate, and shows such a property that, when natural light is incident, a linearly polarized light of a predetermined polarizing axis or a circular polarized light in a predetermined direction is reflected, and the other light is transmitted. The brightness enhanced plate is used for the purpose of improving brightness in a liquid crystal display.

Namely, the brightness enhanced plate is used for the purpose of improving brightness by using a method such as allowing light from a light source such as a backlight to be incident into the brightness enhanced plate so as to obtain a transmitted light in a predetermined polarized state, and allowing the reflected light to be reversed via a reflecting layer or the like to be incident into the brightness enhanced plate again, and allowing all or part thereof to be transmitted as a light in a predetermined polarized state so as to increase the amount of light transmitted through the brightness enhanced plate as well as supplying a polarized light that is hardly absorbed by a polarizing plate so as to increase the amount of light that can be used for liquid crystal display or the like.

Therefore, as the brightness enhanced plate can be used a suitable plate, for example, that shows a property of transmitting a linearly polarized light of a predetermined polarizing axis and reflecting the other light, such as a multi-layer thin film of dielectrics or a multi-layer laminate of thin films having different refractive index anisotropies (D-BEF and others manufactured by 3M Co., Ltd.), or that shows a property of reflecting one of right and left circular polarized lights and transmitting the other light, such as a cholesteric liquid crystal layer, particularly an oriented film of cholesteric liquid crystal polymer or one in which the oriented liquid crystal layer is supported on a film base material (PCF350 manufactured by NITTO DENKO CORPORATION, Transmax manufactured by Merck Co., Ltd., and others).

In the aforesaid brightness enhanced plate of a type that transmits a linearly polarized light of a predetermined polarizing axis, the light can be efficiently transmitted while restraining the absorption loss by the polarizing plate, by allowing the transmitted light to be incident, as it is, into the polarizing plate with aligned polarized axis.

On the other hand, in the brightness enhanced plate of a type that transmits a circular polarized light, such as a cholesteric liquid crystal layer, it is preferable to allow the light to be incident into the polarizing plate after converting the transmitted circular polarized light into a linearly polarized light via a retardation plate instead of allowing the light to be incident, as it is, into the polarizing plate to restrain the absorption loss. The circular polarized light can be converted into a linearly polarized light by using a quarter wavelength plate as the retardation plate and disposing the plate between the polarizing plate and the brightness enhanced plate.

A retardation plate that functions as a quarter wavelength plate in a wide wavelength range such as a visible light region can be obtained by a method such as superposing a retardation layer that functions as a quarter wavelength plate to a monochroic light such as a 550 nm wavelength light, onto a retardation layer that shows a different retardation characteristics, for example, a retardation layer that functions as a half wavelength plate. Therefore, the retardation plate to be disposed between the polarizing plate and the brightness enhanced plate may be made of one or more layers of retardation layers.

Also, as to the cholesteric liquid crystal layer, one can obtain a layer that reflects a circular polarized light in a wide wavelength range such as a visible light region by providing a configuration structure in which two or more layers are superposed using a combination of layers having different reflection wavelengths.

An optical member according to the present invention is constructed in such a manner that the surface of an optical material is bonded to and covered with a protective film whose outer surface has a surface roughness Ra of at least 0.03 μm, for the purpose of preventing damages. Such a protective film may be disposed on both front and back surfaces of the optical material. A typical optical member is constructed in such a manner that a protective film 1 is disposed on one surface of the optical material, and an adhesive layer 3 provisionally bonded to and covered with a separator 4 is disposed on the other surface of the optical material, as in the illustrated examples.

Further, an optical member according to the present invention is constructed in such a manner that an adhesive layer for bonding to another member such as a liquid crystal cell is disposed on an uttermost surface of one surface or both surfaces of the optical material, and the adhesive layer is provisionally bonded to and covered with a separator whose outer surface has a surface roughness Ra of at least 0.03 μm. Therefore, the separator may be disposed on both front and back surfaces of the optical material. A typical optical member is constructed in such a manner that an adhesive layer 3 disposed on one side of the optical material is provisionally bonded to and covered with a separator 4, and the other surface side of the optical material is bonded to and covered with a protective film 1 for the purpose of preventing damages on the surface, as in the illustrated examples.

In the above, protective film 1 may be formed of a protective base alone; however, a typical protective film 1 is formed in such a manner that an adhesive layer is disposed on a protective base so that the protective base can be released together with the adhesive layer from the optical material. On the other hand, separator 4 is formed so that separator 4 can be released at the interface with adhesive layer 3 to which separator 4 is bonded.

Therefore, generally, when the protective film is released, the surface of the optical material is exposed, whereas when the separator is released, the adhesive layer remains on the optical member, so that the adhesive layer can be used for bonding to another member such as a liquid crystal cell. The protective film can be formed so that the adhesive layer to which the protective film is bonded may remain on the optical material, in the same manner as the separator.

The adhesive substance or adhesive agent forming the adhesive layer to be disposed on the protective base or the adhesive layer to be left on the optical material, is no particular limited, can used a suitable one. An example thereof is an adhesive containing a suitable polymer such as an acryl series polymer, a silicone series polymer, polyester, polyurethane, polyamide, polyether, fluorine series polymer, or rubber series polymer, as a base polymer.

In particular, for forming an adhesive layer to be left on the optical material, it is preferable to use an adhesive being excellent in optical transparency, exhibiting adhesive characteristics of suitable wettability, cohesiveness, and adhesiveness, and being excellent in weather resistance, heat resistance, and the like, such as an acryl series adhesive.

The separator that is provisionally bonded to and covers the aforesaid adhesive layer is used for such purposes as preventing contamination until the adhesive layer is put to practical use or preventing unnecessary bonding that makes the handling difficult, which is caused by exposure of the adhesive layer. The separator can be formed, for example, by a method of providing a release coating layer made of a suitable release agent such as silicone series, long-chain alkyl series, fluorine series, or molybdenum sulfide on a suitable thin foliate in accordance with the needs, or the like method.

The aforesaid thin foliate to be used may be a suitable one known in the art, such as plastic film, rubber sheet, paper, cloth, nonwoven cloth, net, foamed sheet, metal foil, or a laminate body thereof. The thickness of the thin foliate can be suitably determined in accordance with the strength or the like, and is typically at most 500 μn, preferably from 5 to 300 μm, more preferably from 10 to 200 μm, but is not limited thereto.

In addition to the above, the adhesive layer to be left on the optical material is preferably formed of an adhesive having a low moisture absorption and being excellent in heat resistance, in view of preventing a foaming phenomenon or a peeling phenomenon caused by moisture absorption, preventing decrease in the optical characteristics or warpage of the liquid crystal cell caused by thermal expansion difference or the like, hence the formability of a liquid crystal display having a high quality and being excellent in durability.

The adhesive layers may comprise, suitable additives such as natural and synthetic resins, glass fibers, glass beads, fillers and pigments made of metal powders, other inorganic powders, and the like, coloring agents, and antioxidants, which can be blended in accordance with the needs. Further, an adhesive layer exhibiting an optical diffusion property can be made by allowing fine particles to be contained therein.

The adhesive layer can be attached onto the protective base or the optical material by a suitable method. Examples of the method include a method of preparing an adhesive solution of from 10 to 40 wt % by dissolving or dispersing an adhesive substance or a composition thereof into a solvent made of a single one or a mixture of suitable solvents such as toluene and ethyl acetate, and attaching the adhesive solution directly onto the protective base or the optical material by a suitable developing method such as the casting method or the application method, and a method of forming an adhesive layer on a separator in accordance with the above and transferring the adhesive layer onto the protective base or the optical material.

The adhesive layer can also be provided on the protective base or the optical member as superposed layers of those of different compositions, those of different kinds, or the like. The thickness of the adhesive layer can be suitably determined in accordance with the intended usage or the adhesive strength, and is typically from 1 to 500 μm, preferably from 5 to 200 μm, more preferably from 10 to 100 μm. The adhesive layers to be disposed on the protective base or the optical member may be of the same composition or kind, or of different ones.

The protective base for forming the protective film may be made of a suitable thin foliate known in the art, such as plastic film, rubber sheet, paper, cloth, nonwoven cloth, net, foamed sheet, metal foil, or a laminate body thereof. The thickness of the protective base can be suitably determined in accordance with the strength or the like, and is typically at most 500 μm, preferably from 5 to 300 μm, more preferably from 10 to 200 μm.

If the surface of the protective base or the separator constituting the outer surface is smooth, the surface roughness of at least 0.03 μm based on Ra can be formed, for example, by applying a suitable surface roughening treatment method such as the buffing treatment or the embossing processing. The surface roughness Ra on the outer surface of the protective film or the separator is preferably from 0.04 to 10 μm, more preferably at most 5 μm, still more preferably from 0.05 to 1 μm, in view of preventing blocking caused by stacking, preventing decrease in the optical characteristics or adhesive characteristics caused by reflection of the surface roughness on the optical element or the adhesive layer, or the like.

The polarizing film, the retardation plate, the brightness enhanced plate, the transparent protective layer, the adhesive layer or the tacky layer constituting the optical member may be allowed to have an ultraviolet absorbing capability by a method of treating with a ultraviolet absorber such as a salicylic acid ester series compound, a benzophenol series compound, a benzotriazol series compound, a cyanoacrylate series compound, or a nickel complex salt series compound.

The optical member according to the present invention can be used for forming various devices such as a liquid crystal display, and the like purpose. The liquid crystal display can be formed to have a suitable conventional structure, such as transmitting type, reflecting type, or reflecting and transmitting type serving for both purposes in which the optical member according to the present invention is disposed on one side or on both sides of a liquid crystal cell via an adhesive layer from which the separator has been peeled off.

### EXAMPLES

### Example 1

A protective film having an acryl series adhesive layer of 20 μm thickness disposed on the back surface of a polyester film of 50 μm thickness was bonded, via the adhesive layer thereof, onto one surface of a polarizing plate of about 180 μm thickness having a triacetyl cellulose film bonded, via a polyvinyl alcohol series adhesive layer, onto both sides of a polarizing film obtained by stretching a polyvinyl alcohol film of 80 μm thickness fivefold in an aqueous solution of iodine. The surface roughness Ra of the outer surface of the aforesaid protective film was found out to be 0.06 μm by measurement with a surface roughness meter (Surfcom manufactured by Tokyo Seimitsu Co., Ltd., the same applies hereafter).

Subsequently, an acryl series adhesive layer of 25 μm thickness was provided, via a silicone series release coating layer, on the back surface of a separator made of a polyester film of 38 μm thickness, and this was bonded, together with the separator, onto the other surface of the aforesaid polarizing plate to obtain an optical member.

### Example 2

An optical member was obtained in the same manner as in Example 1 except that the separator of the polarizing plate was peeled off, a retardation plate obtained by monoaxially stretching a polycarbonate film at 170° C. was bonded thereto, and the acryl series adhesive layer of 25 μm thickness disposed on the separator was bonded, together with the separator, onto the retardation plate.

### Example 3

An optical member was obtained in the same manner as in Example 2 except that the retardation plate put to use was one in which a discotic liquid crystal layer of a tilted orientation was supported by a film base (WVA02A manufactured by Fuji Film Co., Ltd.).

### Example 4

An optical member was obtained in the same manner as in Example 1, except that a brightness enhanced plate made of a laminate of a film base supporting a cholesteric liquid crystal layer and a quarter wavelength plate (PCF350 manufactured by Nitto Denko Co., Ltd.) was bonded, via an acryl series adhesive layer of 25 μm thickness, onto the polarizing plate from which the protective film had been peeled off, and the peeled protective film was bonded onto the exposed surface of the brightness enhanced plate.

### Comparative Example 1

An optical member was obtained in the same manner as in Example 1 except that the protective film put to use was one whose outer surface had a surface roughness Ra of 0.02 μm.

Evaluation Test

Thirty units of each of the optical members obtained in Examples 1 to 4 and Comparative Example 1 were successively stacked, and the stack was sealed under reduced pressure with an inner bag made of polyethylene and an outer bag made of moisture-proof aluminum. After being left to stand for 48 hours, the bags were opened to examine the presence or absence of blocking. The results are shown in Table 1.

TABLE 1

| | Ex. 1 | Ex. 2 | Ex. 3 | Ex. 4 | Comp. Ex. 1 |
|---|---|---|---|---|---|
| Presence or absence | absent | absent | absent | absent | present |
| of blocking | | | | | |

In the above, each unit was blocked via the protective film surface in Comparative Example 1, whereas no blocking occurred in Examples 1 to 4 and, when the stack was subjected to an automatic bonding processor, the optical member was smoothly separated unit by unit to be bonded onto a liquid crystal cell, and no stoppage of the apparatus caused by catching plural units occurred.

### Example 5

A protective film having an acryl series adhesive layer of 20 μm thickness disposed on the back surface of a polyester film of 50 μm thickness was bonded, via the adhesive layer thereof, onto one surface of a polarizing plate of about 180 μm thickness having a triacetyl cellulose film bonded, via a polyvinyl alcohol series adhesive layer, onto both sides of a polarizing film obtained by stretching a polyvinyl alcohol film of 80 μm thickness fivefold in an aqueous solution of iodine.

Subsequently, an acryl series adhesive layer of 25 μm thickness was provided, via a silicone series release coating layer, on the back surface of a separator made of a polyester film of 38 μm thickness, and this was bonded, together with the separator, onto the other surface of the aforesaid polarizing plate to obtain an optical member. The surface roughness Ra of the outer surface of the aforesaid separator was found out to be 0.06 μm by measurement with a surface roughness meter (Surfcom manufactured by Tokyo Seimitsu Co., Ltd., the same applies hereafter).

### Example 6

An optical member was obtained in the same manner as in Example 5 except that the separator of the polarizing plate was peeled off, a retardation plate obtained by monoaxially stretching a polycarbonate film at 170° C. was bonded thereto, and the acryl series adhesive layer of 25 μm thickness disposed on the separator was bonded, together with the separator, onto the retardation plate.

### Example 7

An optical member was obtained in the same manner as in Example 6 except that the retardation plate put to use was one in which a discotic liquid crystal layer of a tilted orientation was supported by a film base (WVA02A manufactured by Fuji Film Co., Ltd.).

### Example 8

An optical member was obtained in the same manner as in Example 5, except that a brightness enhanced plate made of a laminate of a film base supporting a cholesteric liquid crystal layer and a quarter wavelength plate (PCF350 manufactured by Nitto Denko Co., Ltd.) was bonded, via an acryl series adhesive layer of 25 μm thickness, onto the polarizing plate from which the protective film had been peeled off, and the peeled protective film was bonded onto the exposed surface of the brightness enhanced plate.

### Comparative Example 2

An optical member was obtained in the same manner as in Example 5 except that the separator put to use was one whose outer surface had a surface roughness Ra of 0.02 μm.

Evaluation Test

Thirty units of each of the optical members obtained in Examples 5 to 8 and Comparative Example 2 were successively stacked, and the stack was sealed under reduced pressure with an inner bag made of polyethylene and an outer bag made of moisture-proof aluminum. After being left to stand for 48 hours, the bags were opened to examine the presence or absence of blocking. The results are shown in Table 2.

TABLE 2

| | Ex. 5 | Ex. 6 | Ex. 7 | Ex. 8 | Comp. Ex. 2 |
|---|---|---|---|---|---|
| Presence or absence | absent | absent | absent | absent | present |
| of blocking | | | | | |

In the above, each unit was blocked via the separator surface in Comparative Example 2, whereas no blocking occurred in Examples 5 to 8 and, when the stack was subjected to an automatic bonding processor, the optical member was smoothly separated unit by unit to be bonded onto a liquid crystal cell via the adhesive layer after releasing the separator, and no stoppage of the apparatus caused by catching plural units occurred.

What is claimed is:

1. An optical member in which a surface of an optical material is bonded to and covered with a protective film having a outer surface roughness Ra of at least 0.03 μm.

2. The optical member according to claim 1, wherein the protective film is disposed on one surface of the optical material, and a separator is provided on the other surface of the optical material via an adhesive layer.

3. The optical member according to claim 1, wherein the optical material comprises a polarizing plate.

4. The optical member according to claim 1, wherein the optical material comprises a polarizing plate, and at least one of a retardation plate and a brightness enhanced plate.

5. An optical member in which an adhesive layer disposed on an uttermost surface of an optical material is provisionally bonded to and covered with a separator having a outer surface roughness Ra of at least 0.03 μm.

6. The optical member according to claim 5, wherein the separator is disposed on one surface of the optical material, and a protective film is provided on the other surface of the optical material.

7. The optical member according to claim 5, wherein the optical material comprises has a polarizing plate.

8. The optical member according to claim 5, wherein the optical material comprises a polarizing plate, and at least one of a retardation plate and a brightness enhanced plate.

9. A liquid crystal display having an optical member according to claim 1.
